(19) United States
(12) Patent Application Publication
(10) Pub. No.: US 2004/0056382 A1
(43) Pub. Date: Mar. 25, 2004

(54) Method of molding a vehicle trim component

(76) Inventors: Kenneth W. Shaner, Howell, MI (US); Robert J. Adams, Ypsilanti, MI (US); Todd DePue, Brighton, MI (US); Glenn Cowelchuk, Chesterfield, MI (US)

Correspondence Address: MACMILLAN, SOBANSKI & TODD, LLC, ONE MARITIME PLAZA-FOURTH FLOOR, 720 WATER STREET, TOLEDO, OH, 43604, US

(21) Appl. No.: 10/394,130

(22) Filed: Mar. 21, 2003

Related U.S. Application Data
(60) Provisional application No. 60/412,314, filed on Sep. 19, 2002.

(51) Int. Cl. B29C 45/00

(52) U.S. Cl. 264/255; 264/328.8

(57) ABSTRACT

A method of forming an instrument panel for a vehicle includes first providing a first mold structure having a first surface formed therein, a second mold structure having a second surface formed therein, and a third mold structure having a third surface formed therein. The first mold structure is positioned relative to the second mold structure such that the first and second surfaces are in a spaced relationship with one another to define a first cavity. A first material is introduced into the first cavity to form a substrate. The second mold structure is positioned away from the substrate. The third mold structure is positioned relative to the first mold structure such that the third surface and the substrate are in a spaced relationship with one another to define a second cavity. A second material is introduced into the second cavity to form an outer layer overmolded onto the substrate. The first material is different from the second material.

### CROSS REFERENCE TO RELATED APPLICATIONS

This application claims the benefit of U.S. Provisional Application No. 60/412,314 filed Sept. 19, 2002.

### BACKGROUND OF THE INVENTION

This invention relates in general to vehicle trim components, such as instrument panels, and in particular relates to a method of manufacturing such.

The interior of the vehicle includes a multitude of components for covering various frameworks, instruments, and electrical devices mounted within the interior compartment of a vehicle. Examples of trim components include instrument panels, door panels, center consoles, overhead consoles, and other various interior panels for covering the sides, ceilings, and vertical pillars of the frame members of the vehicle.

The instrument panel is generally positioned underneath the windshield and attached to the frame of the vehicle behind the engine compartment. The instrument panel encloses various vehicle components, such as electrical and ventilation systems, audio systems, vehicle instrument gauges and displays, and auxiliary compartments.

In the past, the trim components, such as instrument panels, were made of metal or plastic and commonly had rigid exterior upper and rear surfaces facing the interior of the vehicle. The upper and rear surfaces of the instrument panel are within reach and direct sight of the occupants of the vehicle. Recently, consumers have been demanding a more aesthetically pleasing exposed surface. It is also preferred that the tactile properties of the surfaces are also more pleasing, such as having soft or elastic properties compared to a relatively rigid surface. Thus, the area of the instrument panel located at the upper and lower surfaces of the instrument panel have been covered in a suitably soft material over the rigid structurally accommodating framework of the instrument panel.

In a known method of manufacturing a trim component such as an instrument panel, a rigid plastic substrate is first formed by an injection molding process. The rigid substrate is produced and generally contoured to conform to the general shape of the finished instrument panel. Next, a relatively soft material, such as urethane, is painted or sprayed over the rigid substrate. Alternatively, the softer material may be formed by spraying the material in a liquefied state onto a die conforming to the shape of the substrate. The material is then cooled and/or cured to form a relatively flexible covering material. The covering material is then later adhesively or otherwise attached to the rigid substrate. This method of manufacturing produces an instrument panel having structural rigidity essentially from the rigid substrate, yet having an outer softer covering.

Another known method of manufacturing an instrument panel includes first producing a relatively soft exterior covering, such as by injection molding or by a painting and spraying process as described above. The instrument panel is then formed by an insert molding process in which the covering is inserted into a portion of a mold cavity, and the remaining portion of the cavity is filled with a liquefied second material which hardens into a rigid substrate. The covering material and the substrate form a molded laminate structure. Although this method of manufacturing is adequate, the necessity of separately forming both the covering and the substrate is time consuming and costly.

It is also sometimes desirable to provide accent regions of the instrument panel having different textured or colored properties than the outer covering. For example, a separate strip of trim molding is often independently manufactured and attached to the instrument panel. Although, the appearance of this type of instrument panel is improved, the process of manufacturing and assembling the accent strip is relatively time consuming and costly.

### BRIEF SUMMARY OF THE INVENTION

This invention relates to a method of forming a trim component for vehicle. The method includes the step of first providing a first mold structure having a first surface formed therein, a second mold structure having a second surface formed therein, and a third mold structure having a third surface formed therein. The first mold structure is positioned relative to the second mold structure such that the first and second surfaces are in a spaced relationship with one another to define a first cavity. A first material is introduced into the first cavity to form a substrate. The second mold structure is positioned away from the substrate. The third mold structure is positioned relative to the first mold structure such that the third surface and the substrate are in a spaced relationship with one another to define a second cavity. A second material is introduced into the second cavity to form an outer layer overmolded onto the substrate. The first material is different from the second material.

Various objects and advantages of this invention will become apparent to those skilled in the art from the following detailed description of the preferred embodiment, when read in light of the accompanying drawings.

### BRIEF DESCRIPTION OF THE DRAWINGS

FIG. 1 is a schematic perspective view of an instrument panel manufactured in accordance with the method of the present invention.

FIG. 2 is a cross-sectional view of a portion of the instrument panel taken along lines 2-2 in FIG. 1.

FIG. 3 is a cross-sectional view of a mold assembly illustrating a preferred method of manufacturing the instrument panel of FIG. 1.

FIG. 4 is a cross-sectional view of another mold assembly illustrating another step of the preferred method of manufacturing the instrument panel of FIG. 1.

### DETAILED DESCRIPTION OF THE INVENTION

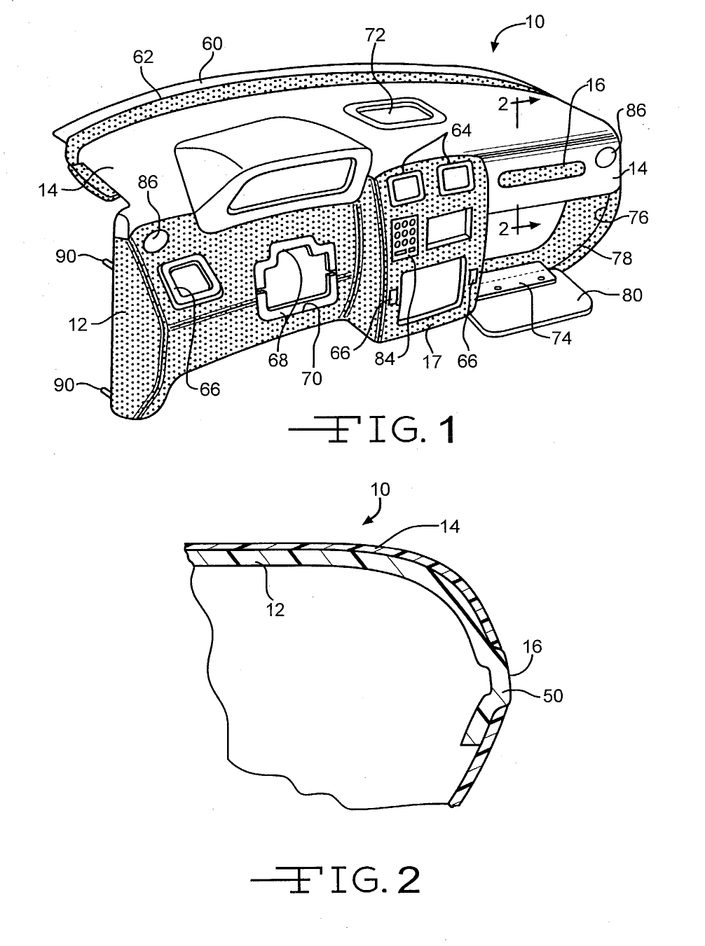

Referring now to the drawings, there is illustrated in FIG. 1, an instrument panel, indicated generally at 10. The instrument panel 10 is an example of a trim component for mounting in an interior cabin of a vehicle. It should be understood that while the method of manufacturing a trim component in accordance with the present invention will be described and shown in FIGS. 1 through 4 with respect to the instrument panel 10, the method may be practiced to form any type of trim component or portions of components for a vehicle formed of at least two different materials. Other suitable examples of trim components which can be formed from the present invention include door panels, center consoles, overhead consoles, and other various interior panels for covering the sides, ceilings, and/or vertical pillars of the frame members of the vehicle.

The instrument panel 10 is installed on a vehicle frame generally in the area underneath the windshield and between the engine compartment and the interior of the vehicle. The instrument panel 10 can include any suitable frame structure (not shown) for supporting the instrument panel 10 to the vehicle frame. The portion of the instrument panel 10 illustrated in FIGS. 1 and 2 preferably defines the upper and a section of the rear portion of the instrument panel facing the interior of the vehicle. Since the upper and rear portion of the instrument are within reach and direct sight of the occupants of the vehicle, it is desirable for this portion of the instrument panel to be aesthetically pleasing in color and texture as well as having a desirable tactile feel, such as a soft or slightly elastic feel.

The instrument panel 10 generally includes a substrate 12 and an outer layer 14. The outer layer 14 generally covers the upper portion and a section of the rear portion of the substrate 12. The exposed surfaces of the substrate 12 are generally represented with stippling in FIG. 1. As will be discussed below in more detail below, an exposed portion 16 of the substrate 12 may be uncovered from the outer layer 14 to provide a two tone or dual material appearance. Portions of the substrate 12, including the exposed portion 16, may be exposed and viewable by passengers of the vehicle. The substrate and the outer layer 14 can have any suitable contour and apertures for receiving various vehicle controls, components and systems. As will also be discussed in detail below, the substrate 12 of the instrument panel 10 can be molded in accordance with the present invention with materials other than the outer layer 14 at various areas to form various features such as seals, pads, gap hiding strips, membranes, living hinges, trays, storage compartment liners, and membrane speakers.

The substrate 12 is preferably made of a relatively rigid material so as to provide support for the outer layer 14, and more preferably is made of a polymer or plastic material. Although additional members or framework may be attached to the substrate 12 for supporting the instrument panel 10 onto the frame of the vehicle, preferably the substrate 12 is rigid enough to structurally support itself and the outer layer 14, since the outer layer 14 preferably has a relatively high elasticity and would generally be unable to support itself across the span of the instrument panel 10. Examples of suitable materials for the substrate 12 include thermoplastic elastomer, thermoplastic elastomer polyolefin, polycarbonate, polypropylene, ABS (acrylonitrile butadiene styrene), polycarbonate ABS, SMA (styrene maleic anhydride), polyphenylene oxide (PPO), nylon, polyester, acrylic, and polysulfone. The substrate 12 can also have any suitable textured surface and color.

Various covers and panels may be attached to the substrate 12 to cover exposed positions thereof. For example, an aesthetically pleasing trim panel, such as a faux wood or carbon fiber panel (not shown) may be used to cover a central portion 17 of the substrate 12. Other components, such as vent covers, display devices, electronic controls, audio/video entertainment units, and the like may be attached to the substrate 12 and covering at least a portion of the substrate 12. Alternatively, all of the exposed portions of the instrument panel 10 may be covered and not seen from within the interior of the vehicle.

The substrate 12 can be formed of a single part or can be formed from attaching separate relatively rigid sections, thereby forming the substrate 12 as shown in FIG. 1. It should also be understood that portions of the substrate 12, such as the lower half thereof illustrated in FIG. 1, can be partially or totally covered in separate trim panels. Also, portions of the substrate 12 may be covered by housings of various vehicle components mounted thereon or within the apertures formed in the substrate 12.

The outer layer 14 is preferably made of a softer material than the substrate 12 and has a generally soft tactile feel compared to the substrate 12. Preferably, the outer layer 14 is made of a polymer or synthetic rubber. Examples of suitable materials for the outer layer 14 include thermoplastic elastomer, thermoplastic elastomer polyolefin. The outer layer 14 can also have any suitable textured surface and color. Preferably, the outer layer 14 is of a different material than the substrate 12 so that the surface of the outer layer has a different tactile characteristic than the surface of the substrate 12. For example, the substrate 12 can have a higher coefficient of friction than the outer layer 14.

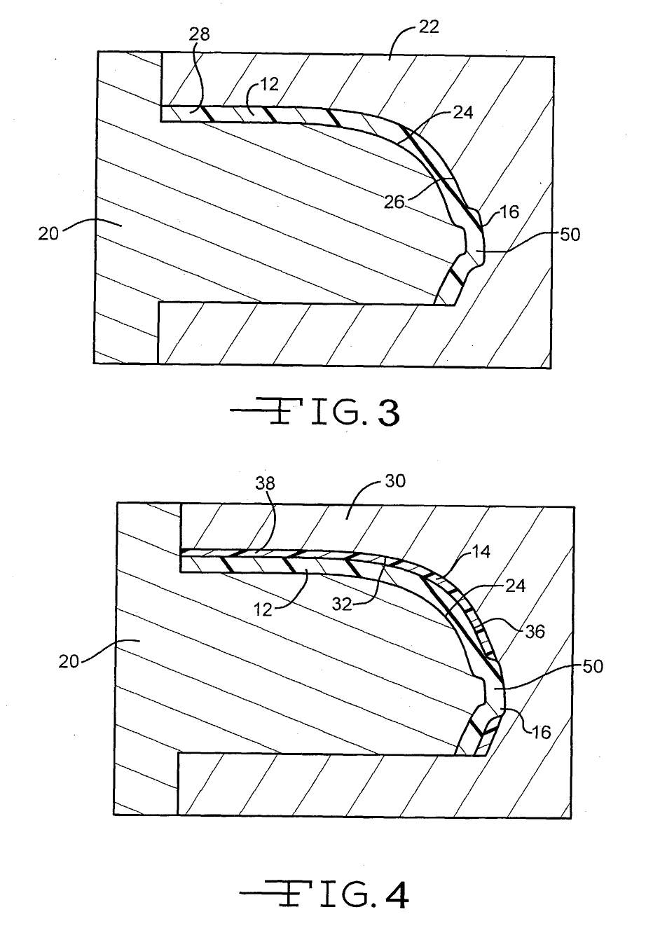

The instrument panel 10 or other vehicle components are preferably manufactured by a generally two step mold process, as schematically illustrated in FIGS. 3 and 4 with respect to the cross sectional view of FIG. 2. As shown in FIG. 3, a first mold structure 20 is movably mounted relative to a second mold structure 22. The mold structures 20 and 22 include contour surfaces 24 and 26, respectively, facing one another in a spaced apart relationship which define a cavity 28. The cavity 28 generally corresponds to the shape and the dimension of the substrate 12. The first and second mold structures 20 and 22 are moved together to their position illustrated in FIG. 3, and a first material (as shown in section in the cavity 28) is introduced into the cavity 28 to form the substrate 12. The first material is introduced into the cavity 28 in a liquefied form and is partially or completely cooled and/or cured to form the substrate 12. The surface 26 corresponds to the rear surface of the substrate 12 facing the interior of the vehicle, as shown in FIG. 1. The surface 24 generally corresponds to the front surface (not viewable in FIG. 1) facing the engine compartment.

Next, the second mold structure 22 is moved from the first mold structure 20, and a third mold structure 30 is generally positioned in its place, as shown in FIG. 4. Preferably, the substrate 12 remains on the first mold structure 20 during replacement of the second mold structure 22. The third mold structure 30 includes a contour surface 32 facing the substrate 12 and the contour surface 24 of the first mold structure 20. The contour surface 32 of the third mold structure 30 and a surface 36 of the substrate 12 are spaced apart from one another to define a cavity 38. The cavity 38 generally corresponds to the shape and dimension of the outer layer 14. A second material is then introduced into the cavity 38 to form the outer layer 14 such that the outer layer 14 is overmolded onto the surface 36 substrate 12.

It should be understood that the first and second materials can be introduced into the cavities 28 and 38 at any suitable temperature and pressure and with or without any other materials, such as for example, a blowing agent. Alternatively, either the substrate 12 and/or the outer layer 14 may be formed by a reaction injection molding process mixing two different materials together, such as a resin and a catalyst. For example, it may be preferred to form the outer layer 14 with a liquid two component urethane injected under low pressure without a blowing agent such that the outer layer 14 remains a solid skin.

The second material of which the outer layer 14 is made of may include an optional adhesive promoter to form a bond between the surface 36 of the substrate 12 and the outer layer 14. The first and second materials could also be heated or maintained at an adequate temperature so that a melted bond formed therebetween. Alternatively, a separate adhesive layer (not shown) could be introduced between the substrate 12 and the outer layer 14 to form a laminated instrument panel 10.

The combination substrate 12 and the outer layer 14 are then removed from first and third mold structures 20 and 30, thereby forming the portion of the instrument panel 10. The mold structures can be any conventional mold structures and positioned and moved by any suitable conventional manner. For example, the first mold structure 20 may remain stationary, and the second and third mold structures 22 and 30 being moved into and out of their respective positions relative to the first mold structure 20. Although the first mold structure is shown and described as being stationary, it should be understood that any of the mold structures can be moved to any position relative to one another throughout the process to manufacture the instrument panel 10.

The instrument panel 10 may be formed such that the outer layer 14 does not completely overmold the substrate 12, thereby revealing the exposed portion 16. This provides an instrument panel 10 having a decorative two-tone, material appearance. As shown in FIG. 4, the third mold structure 30 includes a portion 40 which covers the exposed portion 16 of the substrate 12 to prevent the second material from overmolding onto the substrate 12. Although not necessary, it is preferred that the surfaces of the instrument panel 10 facing the interior of the vehicle are generally flush with one another. To accomplish this, the substrate 12 is formed with an outwardly extending ridge 50 positioned so that its outward surface is flush with the outward surface of the outer layer 14. Although the exposed portion 16 of the substrate 12 is shown at some intermediate point in the instrument panel 10 such that the exposed portion 16 is enclosed or surrounded by the outer layer 14, it should be understood that the exposed portion, or a plurality of exposed portions, may be formed anywhere on the instrument panel 10, for example, on the edge thereof.

The instrument panel 10 illustrated in FIG. 1 includes other generally elastomeric features which can be manufactured in accordance with the present invention as described above. These features, as discussed below, can be over molded onto the substrate 12 in a similar manner as the outer layer 14 is molded on the substrate 12 as described above. An advantage of providing these features molded onto the substrate 12 is that the features do not need to be separately manufactured and then independently located and then attached to the substrate 12, as is conventionally done in the industry, thereby saving reducing costs and manufacturing time.

For example, the instrument panel 10 may include a windshield seal 60 molded on a front edge 62 of the substrate 12. The seal 60 would include an edge or surface portion in contact with and molded to the substrate 12. Another portion of the seal 60 could extend outwardly from the front edge 62. Essentially, the seal 60 would be formed by the method described above with respect to the outer layer 14, in that a second material forming the seal 60 would be introduced into a corresponding shaped cavity functioning similarly to the cavity 38 forming the outer layer 14. Thus, the second material would form the seal 60 instead of the outer layer 14. The second material forming the seal 60 could be the same as or different from the second material forming the outer layer 14. Other suitable seal structures can be formed on the substrate 12. For example, seals 64 having a rectangular loop shape can be molded on the substrate 12. The seals 64 can provide for sealing between the substrate 12 and heating and ventilation controls and vents (not shown) attached to the substrate 12.

Another example of a feature which can be manufactured in accordance with the present invention are vibration and isolation pads 66. The pads 66 are preferably made of a flexible elastomeric second material and can help reduce vibration and noise between the substrate 12 and another trim component, such as a trim cover (not shown) mounted on the substrate 12. The instrument panel 10 may also include gap hiding strips or extensions 68 which extend inwardly from edges of an aperture 70 formed in the substrate 12. The gap hiding strips 68, as shown in FIG. 1, are ideally suited for helping to cover or conceal the exposed opening between the aperture 70 and a movable or non-movable steering column (not shown) extending through the aperture 70.

Another example of an elastomeric feature is a liner 72 of a tray formed on the substrate 12. As shown in FIG. 1, the liner 72 can be surrounded by or covered by a portion of the outer layer 14. Alternatively, a liner can be formed within a storage compartment formed from at least a portion of the substrate 12.

Living hinge membranes or strips 74 may also be manufactured in accordance with the present invention. The living hinge strip 74 is attached to two separate components movable relative to one another such that the strip 74 is flexible or deformable so that the first component can pivot relative to the second component at the bending deformable portion of the strip 74. For example, the strip 74 can be formed on the substrate 12 near an opening 76 of a glove box storage compartment. The strip 74 extends from an edge 78 of the opening 76. A glove box door 80 can then be attached to the extended portion of the strip 74. Alternatively, the strip 74 can be simultaneously molded to the substrate 12 and the door 80. The strip 74 is made of a flexible material and is pliable to permit folding thereof, thereby creating a living hinge. A living hinge strip could also be provided between a vehicle center console (function similarly as the substrate 12) and a door or lip member.

A flexible membrane 84 for covering switches and controls, such as for example, a keypad can be molded onto the substrate 12 or outer layer 14 in accordance with the present invention. Thus, the first material of the method of the present invention forms the substrate 12 or the outer layer 14, and another material molded onto the first material forms the membrane 84. Another type of membrane which can be formed are speaker membranes or diaphragms 86. The diaphragms 86 can be molded onto the substrate 12 or the outer layer 14. The diaphragms would be connected to a speaker transducer mechanism (not shown) for providing the speaker function of the diaphragm by rapidly vibrating the diaphragm. Alternatively, speaker covers or grills could be formed integrally with the substrate 12 or outer layer 14 for covering a conventional speaker mounted on the substrate 12 behind the speaker cover.

Variously shaped clips, fasteners, and locator pins 90 could also be molded onto the substrate 12 or the outer layer 14 in accordance with the present invention.

In accordance with the provisions of the patent statutes, the principle and mode of operation of this invention have been explained and illustrated in its preferred embodiment. However, it must be understood that this invention may be practiced otherwise than as specifically explained and illustrated without departing from its spirit or scope.

What is claimed is:

1. A method of forming a component for a vehicle comprising:
a. providing a first mold structure having a first surface formed therein;
b. providing a second mold structure having a second surface formed therein;
c. positioning the first mold structure relative to the second mold structure such that the first and second surfaces are in a spaced relationship with one another to define a first cavity;
d. introducing a first material into the first cavity to form a substrate;
e. positioning the second mold structure away from the substrate;
f. providing a third mold structure having a third surface formed therein;
g. positioning a third mold structure relative to the first mold structure such that the third surface and the substrate are in a spaced relationship with one another to define a second cavity; and
h. introducing a second material into the second cavity to form an outer layer molded to the substrate, wherein the first material is different from the second material.

2. The method of claim 1, wherein the first material has a higher coefficient of friction than the second material.

3. The method of claim 1, wherein the second material has an elastic characteristic.

4. The method of claim 3, wherein the first material has a generally rigid characteristic for structurally supporting the second material.

5. The method of claim 1, wherein the first material is made of a material selected from the group consisting of thermoplastic elastomer, thermoplastic elastomer polyolefin, polycarbonate, polypropylene, acrylonitrile butadiene styrene, polycarbonate acrylonitrile butadiene styrene, styrene maleic anhydride, polyphenylene oxide, nylon, polyester, acrylic, and polysulfone.

6. The method of claim 1, wherein the second material is made of a material selected from the group consisting of thermoplastic elastomer, thermoplastic elastomer polyolefin, and sanoprene.

7. The method of claim 1, wherein one of the first and second materials includes an adhesive promoter to form a bond between the substrate and the outer layer.

8. The method of claim 1, wherein the outer layer is formed such that outer layer does not completely overmold the substrate, thereby revealing an exposed portion of the substrate.

9. The method of claim 8, wherein the third mold structure includes a portion which covers the exposed portion of the substrate to prevent the second material from overmolding onto the substrate when the second material is introduced into the second cavity.

10. The method of claim 9, wherein the substrate is formed with an outwardly extending ridge positioned so that an outward surface of the ridge is flush with an outward surface of the outer layer.

11. The method of claim 8, wherein the exposed portion of the substrate is positioned at an intermediate location of the outer layer such that the exposed portion is enclosed by the outer layer.

12. The method of claim 1, wherein the outer layer covers a portion of the substrate.

13. The method of claim 1, wherein the outer layer extends outwardly from a portion of the substrate.

14. The method of claim 1, wherein the component is an instrument panel for a vehicle.

15. The method of claim 1, wherein the outer layer is made of a flexible material to form a living hinge.

16. The method of claim 1, wherein the outer layer is a speaker diaphragm.

17. The method of claim 1, wherein the outer layer is a membrane for covering a keypad.

18. A method of forming a component for a vehicle comprising:
a. providing a first mold structure having a first surface formed therein, a second mold structure having a second surface formed therein, and a third mold structure having a third surface formed therein;
b. positioning the first mold structure relative to the second mold structure such that the first and second surfaces are in a spaced relationship with one another to define a first cavity;
c. introducing a first material into the first cavity to form a substrate;
d. positioning the second mold structure away from the substrate;
e. positioning a third mold structure relative to the first mold structure such that the third surface and the substrate are in a spaced relationship with one another to define a second cavity;
f. introducing a second material into the second cavity to form an outer layer overmolded onto the substrate, wherein the first material is different from the second material, and wherein the third mold structure includes a portion which covers an exposed portion of the substrate to prevent the second material from overmolding onto the substrate when the second material is introduced into the second cavity, and wherein the second material has a different tactile characteristic than the first material, and the first material has a generally rigid characteristic for structurally supporting the second material.
